(19) United States
(12) Patent Application Publication
(10) Pub. No.: US 2023/0402760 A1
(43) Pub. Date: Dec. 14, 2023

(54) ANTENNA MAST SUPPORT ASSEMBLY

(71) Applicant: Winegard Company, Burlington, IA (US)

(72) Inventors: Joshua Richard Gallerick, Mt. Pleasant, IA (US); Robert Michael Perrenoud, Mt. Pleasant, IA (US)

(73) Assignee: Winegard Company, Burlington, IA (US)

(21) Appl. No.: 17/881,914

(22) Filed: Aug. 5, 2022

Related U.S. Application Data
(60) Provisional application No. 63/352,082, filed on Jun. 14, 2022.

(51) Int. Cl. H01Q 9/34; H01Q 1/32

(52) U.S. Cl. CPC H01Q 9/34; H01Q 1/3291

(57) ABSTRACT

An antenna mast support kit comprising: a generally L-shaped structure having: a tubular leg portion; and an elongate foot portion fixedly attached to the tubular leg portion; a tubular connector member; attachment components useable to releasably secure the tubular connector member to a stationary object; and an anchor plate removably attachable to the tubular connector member, the anchor plate being positionable under a vehicle tire to stably hold the anchor plate against a base surface; the antenna mast support kit comprising a plurality of operating configurations in which an antenna mast is supported within the tubular leg portion comprising: a first operating configuration wherein the tubular connector member is removably attached to the anchor plate and has the elongate foot portion inserted therein and removably attached thereto.

### PRIOR APPLICATION

This application claims priority from Provisional U.S. Application Ser. No. 63/352,082, filed Jun. 14, 2022 for ANTENNA MAST SUPPORT ASSEMBLY of Gallerick and Perrenoud, which is hereby incorporated by reference for all that it contains.

### BACKGROUND

Many people, when making travel trailer/recreational vehicle (collectively “RV”) outings, take their entertainment systems with them. Since RV campgrounds and other RV parking environments may or may not have satellite receivers, cable television or other signal receivers onsite, many RV campers set up their own antennas near their vehicles. For optimal signal reception it is desirable to mount such antennas above signal obstructing structures, such as neighboring RVs or building.

### SUMMARY OF THE INVENTION

An antenna mast support kit including a generally L-shaped structure having a tubular leg portion and an elongate foot portion fixedly attached to the tubular leg portion. The kit also includes a tubular connector member and attachment components useable to releasably secure the tubular connector member to a stationary object. The kit further includes an anchor plate removably attachable to the tubular connector member. The anchor plate is adapted to be stably held against a base surface such as the ground, paved surface, or other flat base surface by a tire of a vehicle driven onto the anchor plate. The antenna mast support kit has a plurality of operating configurations in which an antenna mast is supported within the tubular leg portion. In a first operating configuration the tubular connector member is attached to the anchor plate and has the elongate foot portion of the generally L-shaped structure inserted in the tubular connector member and removably attached to the tubular connector member.

An antenna mast support assembly including a generally L-shaped structure having a tubular leg portion with an elongate foot portion attached to and extending outwardly from the tubular leg portion and generally perpendicular to the tubular leg portion. The assembly also includes a tubular connector member having a central cavity shaped to closely slidingly receives the tubular leg portion of the generally L-shaped structure and further includes an anchor plate attachable to the tubular connector member. The anchor plate is positionable under a vehicle tire to stably hold the anchor plate against a base surface and thereby maintain the leg portion and any antenna mast inserted into the leg portion in a generally vertical orientation.

A method of supporting an antenna mast in a first antenna mast mounting configuration includes securing a tubular connector to an anchor plate; moving a vehicle wheel onto the anchor plate; inserting a foot portion of an L-shaped structure into the tubular connector; and inserting an antenna mast into a generally vertically oriented leg portion of the L-shaped structure.

A method of using an antenna mast support kit may include, in a second antenna mast mounting configuration, mounting a tubular connector on an elongate beam member; inserting a foot portion of an L-shaped structure into the tubular connector; and inserting an antenna mast into a tubular leg portion of the L-shaped structure.

The method of using an antenna mast support kit may include, in a third antenna mast mounting configuration, inserting the foot portion of the L-shaped structure into a tubular cavity of a vehicle hitch receiver tube, and sliding an antenna mast into the tubular leg portion of the L-shaped structure.

A method of supporting an antenna mast with an antenna mast support kit in a plurality of configurations wherein the kit includes: an L-shaped structure including a tubular leg portion that extends vertically in a normal operating orientation of the L-shaped structure and a foot portion attached to the tubular leg portion that extends horizontally outwardly from the leg portion in the normal operating orientation of the L-shaped structure; a tubular connector member with an elongate tubular cavity; and an anchor plate; wherein the method comprises supporting the antenna mast in a first kit configuration by: securing the tubular connector to the anchor plate; moving a vehicle wheel onto the anchor plate; inserting the foot portion of the L-shaped structure into the tubular connector; and inserting an antenna mast into the tubular leg portion.

The method of supporting an antenna mast with an antenna mast support kit in a plurality of configurations may also comprise moving the tubular leg portion to a lateral position in noninterfering relationship with the vehicle with the wheel on the anchor plate by laterally displacing the foot portion within the tubular member.

The method of supporting an antenna mast with an antenna mast support kit in a plurality of configurations may still further comprises supporting the mast in a second kit configuration by mounting the tubular connector on an elongate beam member; inserting the foot portion of the L-shaped structure into the elongate tubular cavity of the tubular connector portion; and inserting an antenna mast into the tubular leg portion.

The method of supporting an antenna mast with an antenna mast support kit in a plurality of configurations may still yet further comprise supporting the mast in a third kit configuration by: inserting the foot portion of the L-shaped structure into a tubular cavity of a hitch receiver tube; and sliding an antenna mast into the tubular leg portion.

A method of supporting an antenna mast with an antenna mast support kit may include mounting a tubular connector member on an elongate beam member by providing a tubular connector member with an attachment plate that is fixedly mounted thereon; providing a second attachment plate; positioning the first attachment plate and the second attachment plate on first and second opposite sides of the elongate beam member; and attaching the first and second plates with elongate connectors extending adjacent to third and fourth opposite sides of the elongate beam member. The method may further comprises moving the antenna mast to a desired vertical height within the tubular leg portion and securing the mast at the desired height by urging a surface of a tensioning device against a surface of the antenna mast.

### BRIEF DESCRIPTION OF THE DRAWINGS

FIG. 1 is a perspective view of a first configuration of an antenna mast support kit.

FIG. 2 is a perspective view of an anchor plate of an antenna mast support kit.

FIG. 3 is a first perspective view of a tubular connector member with affixed connector plate of an antenna mast support kit.

FIG. 4 a second perspective view of a tubular connector member with affixed connector plate of an antenna mast support kit.

FIG. 5 is a perspective view of a configuration of the antenna mast support kit in which a generally L-shaped structure is received in a tubular member that is mounted on a horizontal beam with connector plates and bolt assemblies.

FIG. 6 is a perspective view of the antenna mast support kit in the configuration of FIG. 5 from a different perspective.

FIG. 7 is a perspective view of the tubular connector member and affixed connector plate of FIG. 3 attached by bolts and a second connector plate to a beam.

FIG. 8 illustrates the tubular connector member with affixed connector plate, second connector plate and bolts, shown in FIG. 7, from a different perspective.

FIG. 9 is a perspective view illustrating a generally L-shaped structure of an antenna mast support kit.

FIG. 10 a perspective view illustrating the generally L-shaped structure of FIG. 9 from a different perspective.

FIG. 11 illustrates a configuration of the antenna mast support kit attached to a vehicle hitch assembly and used to support a multi-sectional, height adjustable, antenna mast with an antenna mounted at the top thereof.

FIG. 12 illustrates a configuration of an antenna mast support kit in which an L-shaped member is attached to a horizontally extending beam of a trailer and used to support an antenna mast that extends vertically through a tubular leg portion of the L-shaped member to the ground.

### DETAILED DESCRIPTION OF THE INVENTION

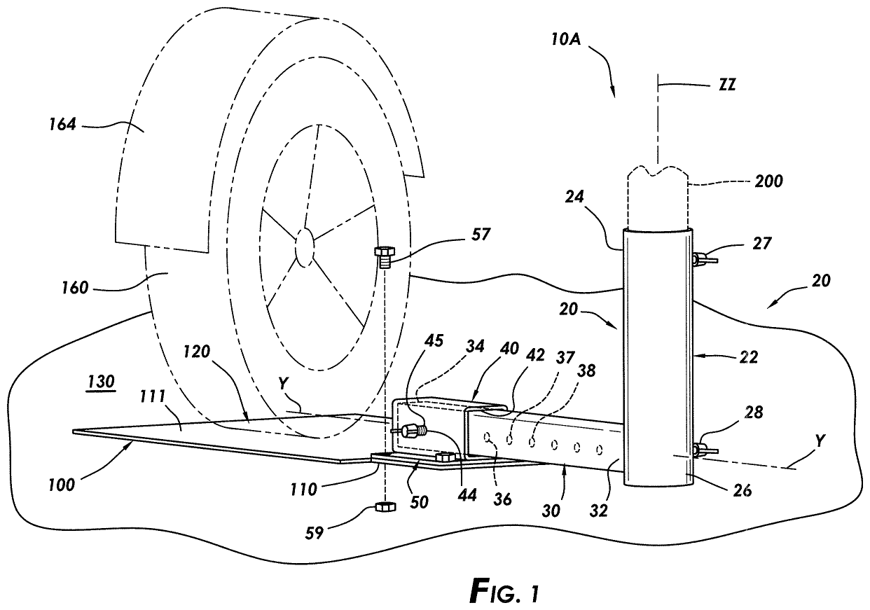

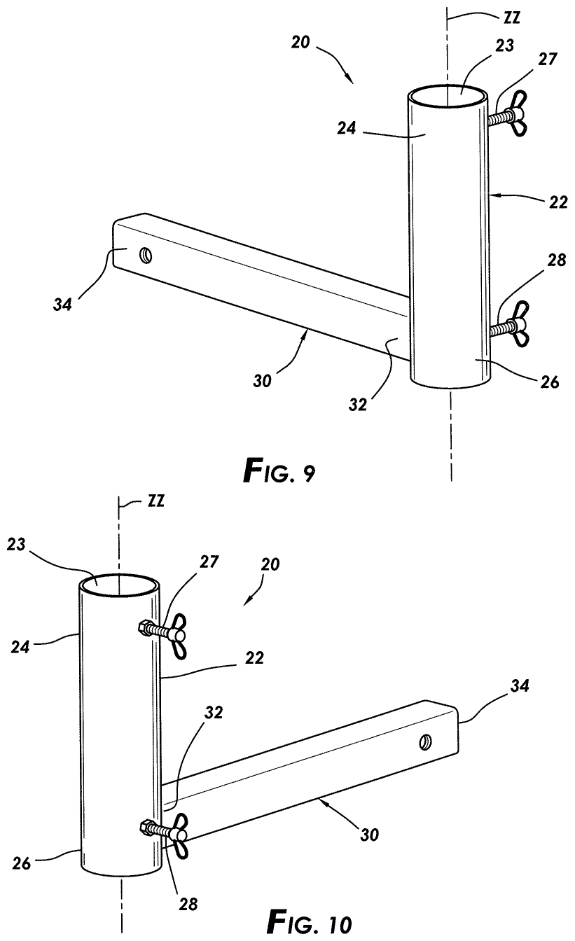

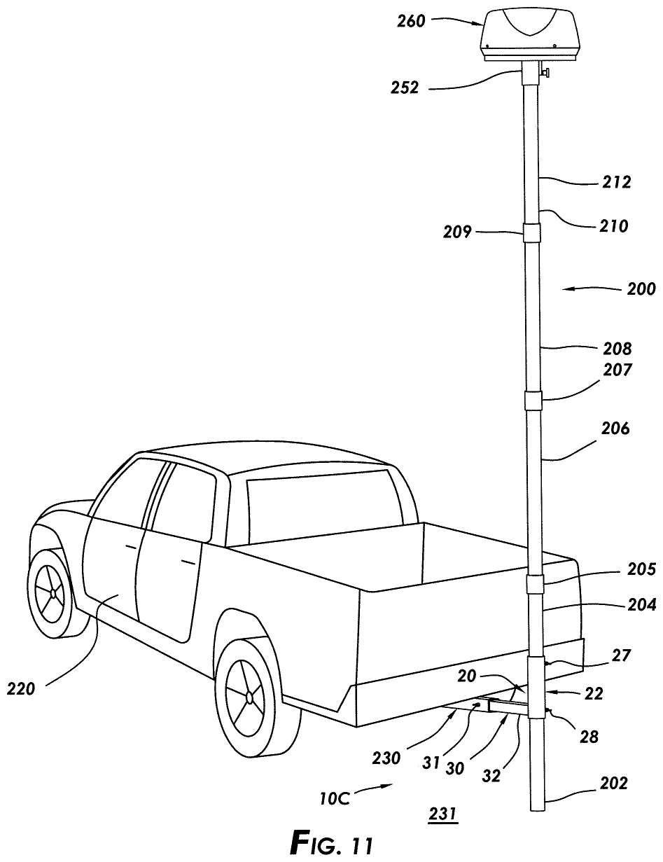

An antenna mast support kit 10, may be arranged in a plurality of different operating configurations 10A, 10B, 10C, FIGS. 1-12, to support an antenna mast 200. The kit 10, in different embodiments thereof, may comprise some of or all of the components described for each of the kit operating configurations 10A, 10B, 10C.

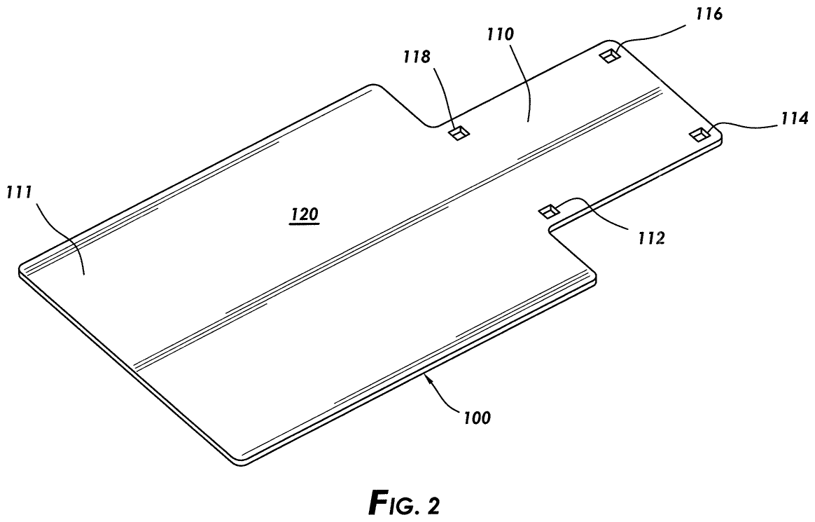

In general, the antenna mast support kit 10 may have a first antenna mast 200 supporting operating configuration 10A is shown in FIGS. 1 and 2. In this operating configuration 10A, a tubular connector member 40 is attached to the anchor plate 100 and the elongate foot portion 30 is inserted into the tubular connector member 40 to removably attached the generally L-shaped structure 20 to the anchor plate.

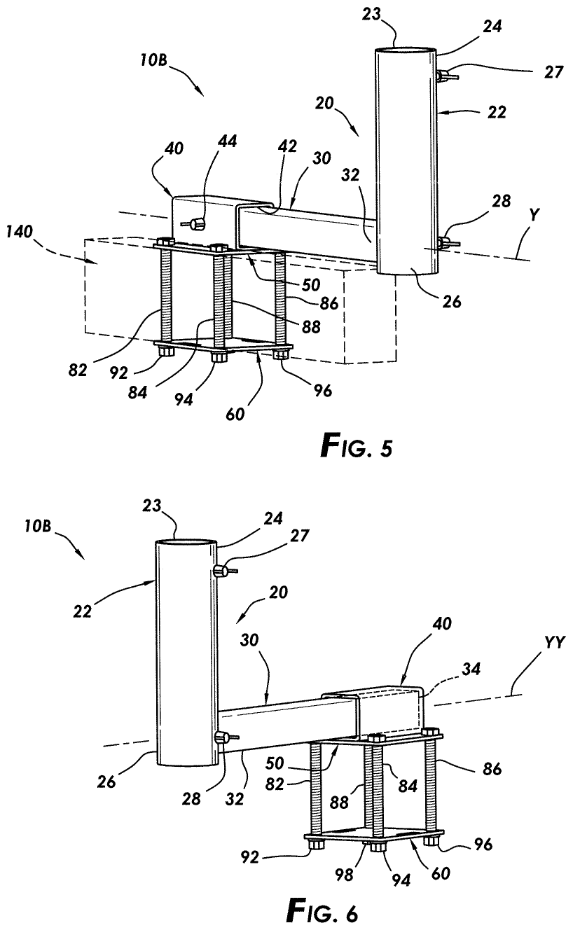

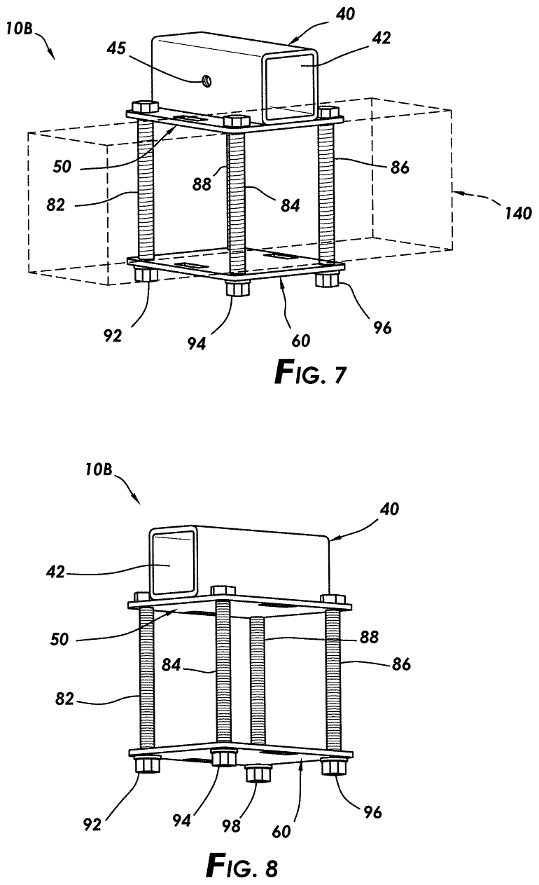

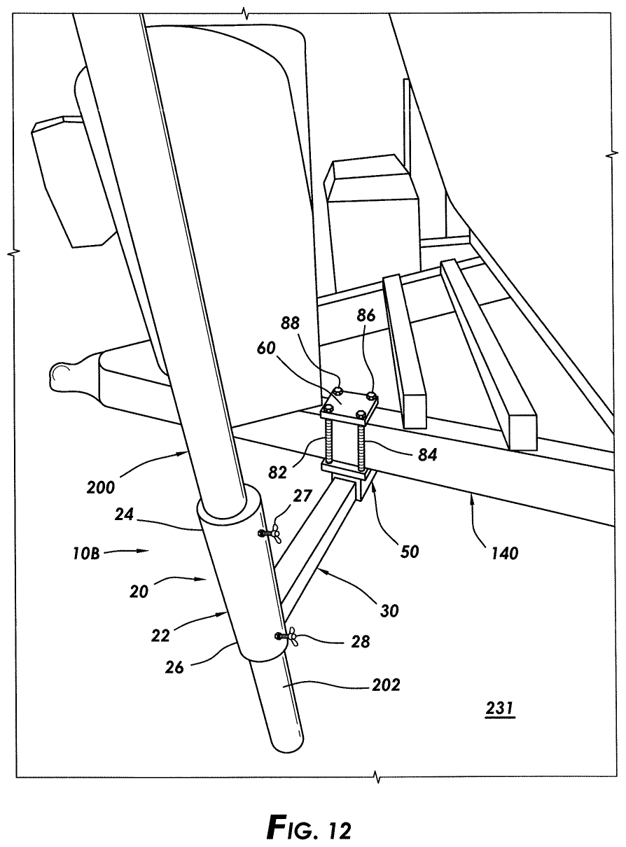

The kit 10 also has a plurality of other operating configurations, 10B, 10C FIGS. 5-12, using components different from or in addition to those shown in FIGS. 1 and 2. In each of these operating configurations an antenna mast 200 is supported within the tubular leg portion 22 of the L-shaped structure 20. The tubular connector member 40 may itself be secured to a stationary object such an elongate beam 140, FIG. 7, by attachment components 50, 60, etc. In another kit configuration 10C, FIG. 11, the L-shaped structure 20 is mounted at the rear of a vehicle 220 by inserting the foot portion 30 thereof into a hitch receiver tube 230 attached to the bumper or frame of the vehicle. Thus, the mast support kit 10 has a plurality of components that may be assembled in several different ways to enable mounting of an antenna mast 200 on a variety of different primary support structures.

Having thus described the antenna mast support kit 10 generally, the various operating configurations of the kit and the components used in the different configurations 10A, 10B, 10C will now be described in greater detail.

### First Configuration 10A

FIGS. 1 and 2 illustrate components of a first configuration 10A of the antenna mast support kit 10. The components of the first configuration 10A include a generally L-shaped structure 20 including: a tubular leg portion 22; and an elongate foot portion 30 fixedly attached to the tubular leg portion 22. An anchor plate 100 is removably attachable to the tubular connector member 40. The anchor plate 100 is positionable under a vehicle tire to stably hold the anchor plate 100 against a base surface 130. The elongate foot portion 30 may be inserted into the tubular connector member 40 attached to the anchor plate 100 so that the tubular leg portion 22 is positioned in a vertical orientation and an antenna mast 200 inserted into the tubular leg portion 22 is also positioned in a vertical orientation. The mast 200 may be maintained at a selected angularly rotated position within elongate foot portion 30 by tensioning screws 27, 28. The tubular leg portion 22 of the L-shaped structure may be positioned at a selected lateral distance from the anchor plate 100 by aligning different ones of the holes 36, 37, 38, etc. of the elongate foot portion 30 with threaded bore 45 of the tubular member 40, and then securing the elongate foot portion 30 to the tubular member 40 by extending attachment screw assembly 44 through bore 45 and the aligned hole in the elongate foot portion 30. In this manner the antenna mast 200 received in the leg portion 22 may be placed in spaced-apart, noninterfering relationship with the vehicle 164 and vehicle tire 160 positioned on top anchor plate 100.

### Second Configuration 10B

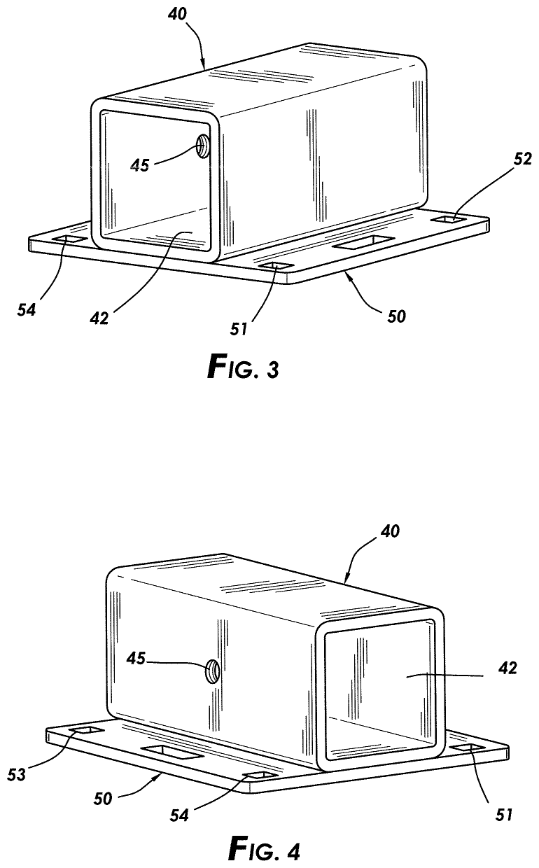

The antenna support kit 10 may have another operating configuration 10B, best shown in FIGS. 5-8 and 11, wherein the tubular connection member 40 is removably mounted on an elongate beam member 140 (such as that of a trailer frame or tongue). In this configuration, the tubular connector member 40 is attached to a horizontal beam 140 of the trailer tongue by sandwiching the tongue between plate 50, which is fixedly attached to tubular connector member 40 as by welding, and a second plate 60. The two plates 50, 60 are positioned on opposite sides of beam 140 and attached by connector bolts 82, 84, 86, 88 received through holes 51-54 in plate 40, FIGS. 3 and 4, and corresponding holes in plate 60. The plates 50, GO are urged into gripping engagement with the beam 140 by nuts 92, 94, 96, 98 threaded onto corresponding bolts 82, 84, 86, 88. The tubular connector member 40 has the elongate foot portion 30 of the L-shaped member 20 inserted into its elongate central cavity 42, FIGS. 3, 4 and 5, and secured therein by connector pin 44, FIG. 5, such that the L-shaped member 20 is removably attached to the beam 140, FIG. 13. An antenna mast 200 can thus be supported in a vertical orientation by inserting it into the vertical leg portion 22 of the L-shaped structure 20. It may be maintained at a selected elevation by use of tensioning screws 27, 28, or simply by allowing the mast bottom portion 202 to contact the ground 231, such as shown in FIG. 12

### Third Configuration 10C

In FIG. 11, in yet another kit configuration 10C, the foot portion 30 of the generally L-shaped structure 20 is inserted into a vehicle mounted hitch receiver tube 230. This enables an antenna mast 200 to be received in the vertically oriented central cavity 24 of the tubular leg portion 22 and supported therein at a desired elevation by use of screws 27, 28. The antenna mast support kit 10 may, in different embodiments thereof, comprise any or all of the components of the kit configurations 10A, 10B, and 10C described herein.

Some components of the kit 10 will now be further described. The antenna mast support kit 10 has attachment components 50, 60, 82, etc., FIGS. 5-8, useable to releasably secure the tubular connector member 40 to a stationary object. The attachment components may include a first plate 50 fixedly attached to the tubular connector member 40. The attachment components may also include a second plate 60. In the antenna support kit configuration 108 shown in the drawings, the attachment components comprise at least one bolt assembly, e.g., bolt 84 and nut 94, mountable in oppositely positioned bores in the first and second plates 50, 60. In FIGS. 5-8, the attachment components include four bolts 82, 84, 86, 88 and corresponding nuts 92, 94, 94, 96 mountable in four sets of oppositely positioned bores 51-54, etc. in the first and second plates 50, 60.

The tubular connector member 40 may be provided with a connector pin 44, which may be a wing screw, receivable through a threaded hole 45 in the tubular connector member 40 and a selected one of alignable holes 36, 37, 38, etc. in the foot portion 30. The connector pin 44 positively holds the tubular connector member 40 at a selected one of a plurality of lateral positions along the foot portion 30 associated with holes 36, 37, 38, etc.

One specific embodiment of the kit 10 will now be described.

In this embodiment the antenna mast support kit 10 includes a generally L-shaped structure 20, FIG. 1, having a tubular leg portion 22 with an elongate central cavity 23, FIG. 5, having a central axis ZZ extending between a first (upper) end portion 24 and a second (lower) end portion 26 thereof. The tubular leg portion 22 is adapted to receive an antenna mast 25 therein, An elongate foot portion 30 extends transversely from the tubular leg portion 22 and has a proximal end portion 32 attached to the second end portion 26 of the tubular leg portion 22. The elongate foot portion 30 has a distal end portion 34. The kit includes a tubular connector member 40 having an elongate central cavity 42 adapted to receive the elongate foot portion 30 therein, FIG. 1. A first connector plate 50 is fixedly attached to the tubular connector member 40, as by welding. The kit 10 includes a second connector plate 60. A plurality of elongate bolts 82, 84, 86, 88 are receivable through corresponding openings in the first and second connector plates 50, 60.

The kit 10 includes an anchor plate 100 that is removably attachable at a first end portion 110 thereof to the first connector plate 50. The anchor plate 100 has a main body portion 120 adapted to have a vehicle tire resting thereon to anchor the plate 100 to a base surface 130 on which it rests. The antenna mast support kit 10 includes a plurality of operating configurations including at least one of the following three operating configurations:
1) A first operating configuration (FIGS. 1-4 & 9-10) wherein the tubular connector member 40 is removable attached to the anchor plate 100 with the central longitudinal axis YY of the tubular connector member 22 oriented parallel to the anchor plate 100. The distal end portion 34 of the foot portion 30 is received in the elongate central cavity 42 of the tubular connector member 40 at an angular orientation therewithin such that the central axis ZZ of the tubular leg portion 22 is positioned generally vertically so that an antenna mast 200 inserted in the tubular leg portion cavity 42 is supported therein in a generally vertical orientation.
2) A second operating configuration (FIGS. 5-8 & 12) wherein the tubular connector member 40 is removably mounted on an elongate beam member 140 by positioning the first and second connector plates 40, 50 on two opposite sides of the elongate beam member 140 and connecting the connector plates with elongate bolts 82, 84, 86, 88 positioned on two other opposite sides of the elongate beam member 140. The distal end portion 34 of the foot portion 30 is received in the elongate central cavity 42 of the tubular connector member 40 at an angular orientation wherein the central longitudinal axis ZZ of the tubular leg portion 22 is positioned generally vertically such that an antenna mast 200 inserted in the tubular leg portion 22 is supported therein in a generally vertical orientation.
3) A third operating configuration (FIG. 11) wherein the distal end portion 34 of the foot portion 30 is received in a hitch receiver tube 230 at an angular orientation therewithin such that the tubular leg portion 22 is oriented generally vertically.

Various embodiments of an antenna mast support kit and methods of use have been disclosed herein in detail. After reading this disclosure various alternative embodiments of the antenna mast support kit will become obvious to those skilled in the art. It is intended that the language of the appended claims be broadly construed to cover such alterative embodiments, except as limited by the prior art.

What is claimed is:

1. An antenna mast support kit comprising:
a generally L-shaped structure having:
a tubular leg portion; and
an elongate foot portion fixedly attached to the tubular leg portion;
a tubular connector member;
attachment components useable to releasably secure the tubular connector member to a stationary object; and
an anchor plate removably attachable to the tubular connector member, the anchor plate being positionable under a vehicle tire to stably hold the anchor plate against a base surface;
the antenna mast support kit comprising a plurality of operating configurations in which an antenna mast is supported within the tubular leg portion comprising:
a first operating configuration wherein the tubular connector member is removably attached to the anchor plate and has the elongate foot portion inserted therein and removably attached thereto.

2. The antenna mast support kit of claim 1 wherein the plurality of operating configurations comprises: an operating configuration wherein the tubular connection member is removably mounted on an elongate beam member and the tubular connection member has the elongate foot portion inserted therein and removably attached thereto.

3. The antenna mast support kit of claim 1 wherein the plurality of operating configurations comprises: an operating configuration wherein the foot portion of the generally L-shaped structure is inserted in a vehicle mounted hitch receiver tube.

4. The antenna mast support kit of claim 2 wherein the plurality of operating configurations comprises: an operating configuration wherein the foot portion of the generally L-shaped structure is inserted in a vehicle mounted hitch receiver tube.

5. The antenna mast support kit of claim 1 wherein the attachment components useable to releasably secure the tubular connector member to a stationary object comprises a first plate attached to the tubular connector member.

6. The antenna mast support kit of claim 5 wherein the attachment components comprise a second plate.

7. The antenna mast support kit of claim 6 wherein the attachment components comprise at least one bolt operably receivable in oppositely positioned bores in the first and second plates.

8. The antenna mast support kit of claim 6 wherein the attachment components comprise a plurality of bolts operably mountable in a plurality of oppositely positioned bores in the first and second plates.

9. The antenna mast support kit of claim 1, the tubular leg portion having top and bottom end openings wherein an antenna mast insertable in the tubular leg portion is extendable below the bottom end opening of the tubular leg portion.

10. The antenna mast support kit of claim 9, the tubular leg portion having a tensioning assembly engageable with an antenna mast inserted in the tubular leg portion such that the antenna mast may be maintained at a selected elevation relative the tubular leg portion.

11. The antenna mast support kit of claim 1 further comprising a connector pin receivable through a hole in the tubular connector member and an aligned hole in the foot portion that positively holds the tubular connector member at a selected one of a plurality of lateral positions relative the foot portion.

12. An antenna mast support kit comprising:
a generally L-shaped structure having:
a tubular leg portion; and
an elongate foot portion attached to the tubular leg portion;
a tubular connector member having a central cavity shaped to closely slidingly receives the tubular leg portion; and
an anchor plate attachable to the tubular connector member, the anchor plate being positionable under a vehicle tire to stably hold the anchor plate against a base surface and thereby maintain the leg portion and any antenna mast inserted therein in a generally vertical orientation.

13. A method of supporting an antenna mast comprising, in a first antenna mast mounting situation comprising:
securing a tubular connector to an anchor plate;
moving a vehicle wheel onto the anchor plate;
inserting a foot portion of an L-shaped structure into the tubular connector; and
inserting an antenna mast into a leg portion of the L-shaped structure.

14. The method of supporting an antenna mast of claim 13 further comprising, in a second antenna mast mounting situation comprising:
mounting a tubular connector on an elongate beam member;
inserting a foot portion of an L-shaped structure into the tubular connector; and
inserting an antenna mast into a tubular leg portion of the L-shaped structure.

15. The method of using an antenna mast kit of claim 13 further comprising, in a third antenna mast mounting situation:
inserting the foot portion of the L-shaped structure into a tubular cavity of a hitch receiver tube; and
sliding an antenna mast into the tubular leg portion of the L-shaped structure.

16. The method of claim 14 wherein mounting the tubular connector member on an elongate beam member comprises:
providing a tubular connector member with an attachment plate that is fixedly mounted thereon;
providing a second attachment plate;
positioning the first attachment plate and the second attachment plate on first and second opposite sides of the elongate beam member; and
attaching the first and second plates with elongate connectors extending adjacent to third and fourth opposite sides of the elongate beam member.

17. The method of claim 13 further comprising moving the antenna mast to a desired vertical height within the tubular leg portion and securing the mast at the desired height by urging a surface of a tensioning device against a surface of the antenna mast.

18. The method of claim 13 further comprising moving the tubular leg portion to a desired lateral position relative the vehicle by laterally displacing the foot portion within the tubular connector member.
